(19) United States
(12) Patent Application Publication
(10) Pub. No.: US 2017/0139998 A1
(43) Pub. Date: May 18, 2017

(54) Search Device and Search Method

(71) Applicant: Kabushiki Kaisha Toshiba, Tokyo (JP)

(72) Inventor: Mikito IWAMASA, Tokyo (JP)

(73) Assignee: Kabushiki Kaisha Toshiba, Tokyo (JP)

(21) Appl. No.: 15/420,528

(22) Filed: Jan. 31, 2017

Related U.S. Application Data
(63) Continuation of application No. PCT/JP2014/080382, filed on Nov. 17, 2014.

(51) Int. Cl. G06F 17/30

(52) U.S. Cl. CPC G06F 17/30483

(57) ABSTRACT

According to one embodiment, a search device includes: a storage to store semantic relationships between components and three-dimensional information of the components; an analyzer to analyze an entered search expression of a component satisfying first and second search conditions wherein the first search condition defines a condition of a component using the semantic relationships and the second search condition defines a condition of a component using the three-dimensional information to thereby generate structure information; a first searcher to interpret and execute a search expression based on the semantic relationships; a second searcher configured to interpret and execute a search expression based on the three-dimensional information; a generator to generate first and second search expressions from parts of the structure information that correspond to the first and second search conditions, respectively; and a search result integrator to integrate the search results of the first search expression and the second search expression.

### CROSS REFERENCE TO RELATED APPLICATIONS

This application is a Continuation of International Application No. PCT/JP2014/080382, filed on Nov. 17, 2014, the entire contents of which is hereby incorporated by reference.

### FIELD

Embodiments of the present invention relate to a search device and a search method.

### BACKGROUND

As one of state of the art search technologies, an existing search technology searches information on a building included in a building information mod& in accordance with a semantic model of building information (for example, defined typically in accordance with the scheme of IFC (Industry Foundation Classes, ISO16739) amongst other schemes). However, these technologies do not utilize three-dimensional information of building components such as shapes and locations of the building components, failing to provide flexible search functionality.

### BRIEF DESCRIPTION OF THE DRAWINGS

FIG. 1 is a block diagram of a search device in accordance with this embodiment;

FIG. 2 is a diagram illustrating an exemplary class diagram;

FIG. 3 is a diagram schematically illustrating a two-dimensional diagram of a certain section in a building;

FIG. 4 is a diagram illustrating a syntax tree obtained by syntax analysis of a search expression;

FIG. 5 is a diagram of the syntax tree illustrated by a hierarchical structure tracing upward relationships;

FIG. 6 is a diagram illustrating a hierarchical structure among blocks;

FIG. 7 is a diagram illustrating an example where the syntax tree is separated into two parts;

FIG. 8 is a flowchart of overall operation of the search device in accordance with this embodiment;

FIG. 9 is a flowchart of detailed operation in an analysis process;

FIG. 10 is a flowchart of detailed operation in a search expression separation process;

FIG. 11 is a flowchart of detailed operation in a search processing and integration process; and

FIG. 12 is a diagram illustrating a hardware configuration of the search device.

### DETAILED DESCRIPTION

According to one embodiment, a search device includes: a hardware storage, an analyzer, a first searcher, a second searcher, a generator and a search result integrator. The hardware storage is configured to store with regard to a plurality of components arranged in a three-dimensional space, semantic relationships between the components and three-dimensional information of the components.

The analyzer is implemented by a processor configured to analyze an entered search expression including a first search condition and a second search condition to search a component satisfying the first search condition and the second search condition, wherein the first search condition defines a condition of a component using the semantic relationships and the second search condition defines a condition of a component using the three-dimensional information, to generate structure information of the entered search expression.

The first searcher is implemented by a processor configured to interpret and execute a search expression based on the semantic relationships.

The second searcher is implemented by a processor configured to interpret and execute a search expression based on the three-dimensional information,

The generator is implemented by a processor configured to generate a first search expression that is adapted to be interpreted by the first searcher from a part of the structure information that corresponds to the first search condition, generate a second search expression that is adapted to be interpreted by the second searcher from a part of the structure information that corresponds to the second search condition, and generate integration information for integration of search results of the first search expression and the second search expression.

The search result integrator is implemented by a processor configured to integrate the search result of the first search expression by the first searcher and the search result of the second search expression by the second searcher on the basis of the integration information and identify a component that satisfies the entered search expression from the plurality of components.

Embodiments of the present invention are described below with reference to drawings.

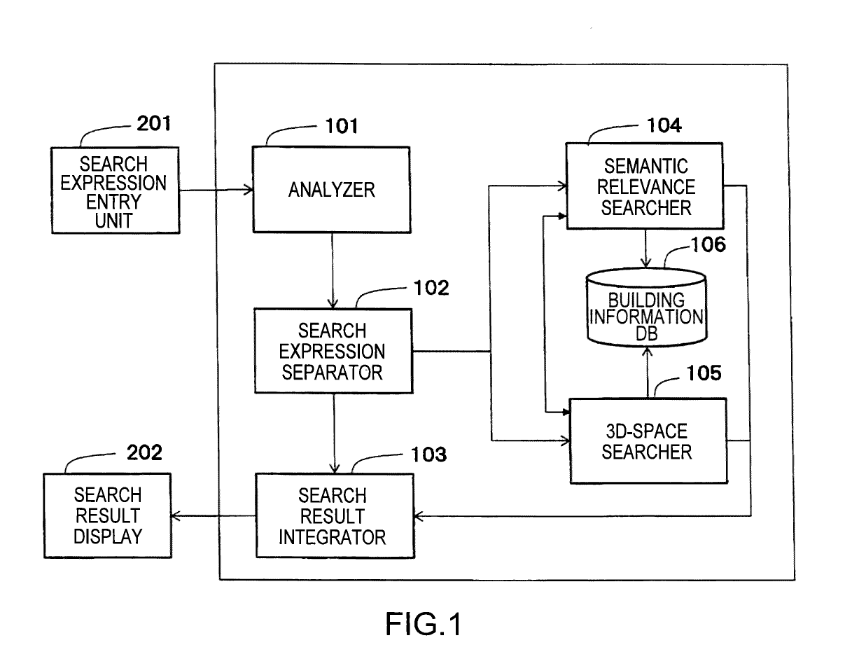

FIG. 1 illustrates a block diagram of a search device in accordance with this embodiment. A building information database (DB) (i.e., storage) 106 is configured to store information (i.e., “relational model”) indicative of a semantic relationship formed between components (or objects) arranged in a three-dimensional space, in particular between components (or objects) arranged in a building which is constituted by these components (or objects). Also, the building information DB 106 stores pieces of “three-dimensional (3D) information” or “three-dimensional (3D) models” of the individual components. The three-dimensional information includes information on geometry (i.e., geometry information). The geometry information is described based on an absolute coordinate system of the space occupied by a building and accordingly includes location information of an article. The building information DB 106 will be described later in detail.

A search expression entry unit 201 is an interface used to enter a search expression (or a search formula). The search expression entered by the search expression entry unit 201 includes a “first search condition” and a “second search condition.” The first search condition defines a condition of a component using the semantic relationship whilst the second search condition defines a condition of a component using the three-dimensional information. The search expression is for use in searching for a component that satisfies the first search condition and the second search condition. The search expression entry unit 201 by way of example may be an interface such as a touch panel, a mouse, a keyboard, or the like that is used by a user, a storage device in which the search expression is stored, or a read drive, etc. that reads data from a recording medium. The storage device may include a device or non-volatile memory that permanently stores information such as an SSD, a hard disk, a USB memory or the like or volatile memory such as DRAM. The read drive may include, by way of example, a drive such as DVD, CD-ROM, and the like.

An analyzer 101 is connected to the search expression entry unit 201. The analyzer 101 is configured to carry out syntax analysis for the search expression entered by the search expression entry unit 201 and generate structure information of the search expression. Specifically, the analyzer 101 converts the search expression into the one having a format which a search expression separator 102 is capable of interpreting, for example, into a tree structure. This embodiment envisages a case where the search expression is converted into the tree structure. The analyzer 101 is connected to the search expression separator 102 and outputs the search expression in the form of the tree structure obtained by the above conversion to the search expression separator 102.

The search expression separator 102 is configured to receive the tree structure from the analyzer 101 and decompose it into a part associated with semantic-relationship-based search and another part associated with three-dimensional (3D) space search (which may also be referred to as “spatial search”), and generate therefrom a search expression (“semantic relevance search expression”) that can be interpreted by a semantic relevance searcher 104 (i.e., first searcher) and a search expression (“3D-space search expression”) that can be interpreted by a three-dimensional (3D) space searcher 105 second searcher). Three-dimensional (3D) space search refers to search using the three-dimensional information in the three-dimensional space, by way of example, search for an object (component) included in a specified range in the three-dimensional space. The range may be specified by any appropriate methods, for example, by a starting point (viewpoint), azimuth, and/or shape, or may be specified as an intersection region of two or more ranges in the three-dimensional space. A state where an object is included in the specified range may refer to a state where the entire object is included in the range or a state where at least part of the object is included in the range. Also, the search expression separator 102 is configured to generate integration information (“integration script”) which represents a procedure for integrating a result of search by the semantic relevance search expression and a result of search by the 3D space search expression. The integration script according to one embodiment is a script describing the process of applying a result of execution of the semantic relevance search expression (“search result”) to the 3D space search expression and obtain a search result (component) that satisfies the 3D-space search expression from among the search result (components) of the semantic relevance search expression.

The semantic relevance searcher 104 is connected to the search expression separator 102 and configured to receive the semantic relevance search expression from the search expression separator 102. The semantic relevance searcher 104 searches the building information DB 106 on the basis of the semantic relevance search expression and obtains a desired building component (object) as the search result. The semantic relevance searcher 104 is capable of interpreting and executing the search expression described, for example, by a predetermined query language. The operation of the semantic relevance searcher 104 can be controlled by the search result integrator 103.

The 3D space searcher 105 is connected to the search expression separator 102 and configured to receive the 3D-space search expression from the search expression separator 102. The 3D space searcher 105 carries out search using the three-dimensional information in the building information DB 106 on the basis of the 3D space search expression. The 3D space searcher 105 is capable of interpreting and executing the search expression described, for example, by a predetermined procedural language. The operation of the 3D space searcher 105 can be controlled by the search result integrator 103.

The search result integrator 103 is connected to the search expression separator 102 and configured to receive the integration script from the search expression separator 102. Also, the search result integrator 103 is connected to the semantic relevance searcher 104 and the 3D space searcher 105 and configured to integrate the search result of the semantic relevance searcher 104 and the search result of the 3D space searcher 105 on the basis of the integration script. Specifically, the search result integrator 103 executes the 3D space search expression in accordance with the integration script and on the basis of the search result of the semantic relevance search expression, and thereby identifies a component that satisfies the search expression entered by the search expression entry unit. The search result integrator 103 outputs the information of the obtained result (the information indicative of the component that satisfies the search expression entered by the search expression entry unit 201) to a search result display 202.

The search result display 202 is connected to the search result integrator 103 and configured to display the information indicative of the search result (component) entered by the search result integrator 103. The search result display 202 is a screen device that displays the search result, which is, by way of example, a liquid crystal display device. It may be a single independent display or may be a display of a portable terminal.

The information may be output in the form of a text or texts, or the component that was searched for may be displayed by a three-dimensional image.

Here, as described above, the information on the semantic relationship (the relational model) formed between the components (or objects) constituting the building is stored in the building information DB 106. The relational model includes, by way of example, a building information model (BIM). The format of the relational model may be defined as appropriate. By way of example, the relational model includes entities classified on a per-component basis for the components constituting the building, and a relationship formed between the entities (semantic relationship). For example, it may be a database (relational model) whose schema is IFC (Industry Foundation Classes, ISO16739) which defines semantic information including a connection relationship between entities. In this case, the relational model may be expressed by a class diagram.

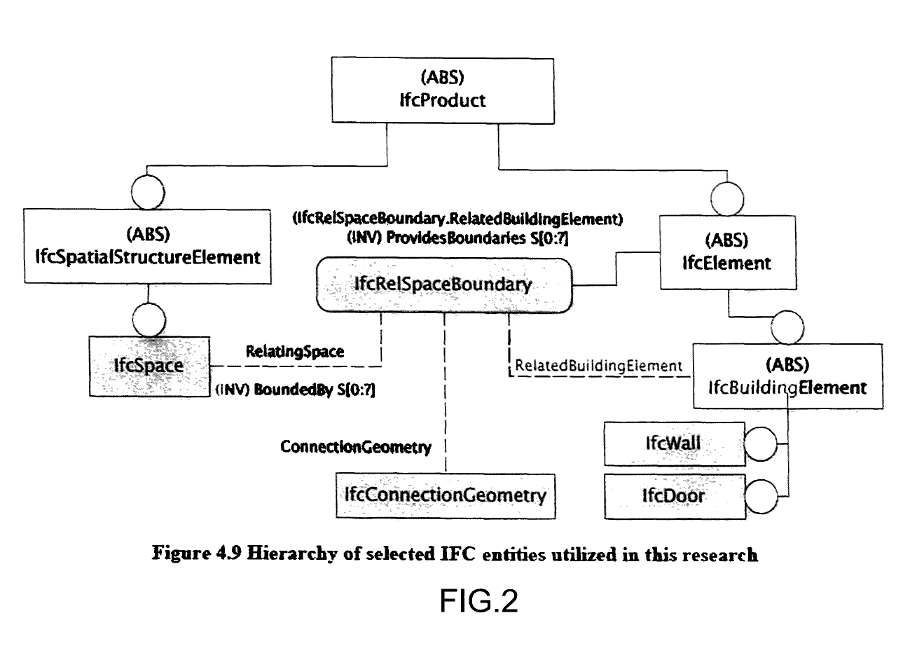

FIG. 2 illustrates a class diagram taken from ISO 16739:2013 Industry Foundation Classes (IFC) for data sharing in the construction and facility management industries. A rectangular frame indicates a class of a product or component and a rectangular frame with its four corners curved in a shape of an arc indicates a class indicative of the relationship between the classes (in this example, “IfcRelSpaceBoundary”). A solid linear line connecting an upper rectangle to a lower rectangle represents an “is-a” relationship from the upstream class to the downstream class. For example, “IfcProduct” is an “IfcElement.”

With regard to an example of the semantic information, for example, a door (“IfcDoor”) and a room (“IfcSpace”) connected to the door are associated with each other by a relationship (“IfcReiSpaceBoundary”). Specifically, if the relationship is traced starting from the door (IfcDoor) to reach the room (IfcSpace), then they are associated with each other as the properties by “(INV)ProvidesBoundaries S[0:?]” and “RelatingSpace,” Meanwhile, if the relationship is traced starting from the room (IfcSpace) to reach the door (IfcDoor), then they are associated with each other by “(INV)BoundedBy S[0:?]” and “RelatedBuildingElemet.”

“ABS” means “ABSTRACT” and a rectangular class labeled by an “ABS” is an abstract class. A rectangular class that is not labeled by an “ABS” is a conventional class whose instance can be generated.

The building information DB 106 is described in more detail below on the basis of a specific case example.

Components (instances) constituting a building are classified on a per-type (class) basis in the building information DB 106 in accordance with the notion of the object orientation. An instance is an object that has a unique state obtained by substantiation of the class. Also, the relationship regarding inheritance between classes (the aforementioned “is-a” relationship), the structural hierarchical relationship (“has-a” relationship), and the relationship specific to the building formed between classes (e.g., connection) are recorded. The building information DB 106 also has information regarding the properties (attributes) of the individual components.

Also, as described in the foregoing, the building information DB 106 has the geometry information of the individual components. The geometry information is described based on the absolute coordinate system of the space occupied by the building.

In addition, the building information DB 106 may include a searcher in accordance with the notion of object-oriented DB. As an example of the building information DB having such a searcher, a BIM server may be mentioned. The BIM server reads building information from an IFC file described in accordance with the BIM standard and retains the read building information as a database compliant with the notion of object orientation. The BIM server uses this database and provides search services executing search expressions whose typical example is SQL. An external device transmits the search expression to the BIM server and receives the search result from the BIM server. As an example of the existing language technologies for storing the BIM models in the database and carrying out search therefor, BIMQL (Building Information Model Query Language) may be mentioned.

The following illustrates an exemplary search using information on the relationship formed between components (objects) (the semantic relationship such as “connection”).

### EXAMPLE 1

To be supposed is a case that two rooms are interconnected via a door. It is assumed in this illustrated example that a search is performed to find a door causing a difference equal to or larger than 200 mm between the heights of the floors of the two rooms. An example search expression of this case is illustrated below as a “search expression 1.” The search expression is entered by the search expression entry unit 201. In addition to direct entry of the search expression, when a 3D model editor is used, the connection between the door and the rooms and the relationship between the floors may be entered as a three-dimensional diagram. In this case, the entered 3D diagram is expanded into the search expression by the analyzer 101 or any other suitable methods. It is assumed here that the search expression describes the specific status in the three-dimensional space, and a search expression that does not have a procedural process or control syntax is envisaged here. It is also assumed for the sake of explanation that the search expression used in this embodiment is compliant with an SQL-like grammar. It should be noted that the following “Abs( )” is a function to calculate an absolute value.

### <Search Expression 1>

Select $Var1
Where $Var1.type==IfcDoor
Rooms=$Var1.ConnectedSpace
Abs(Rooms[0].floor.height ?Rooms[1].floor.height)>200

“IfcDoor” specifies an instance whose type is “Door”. According to this search expression, an instance that satisfies the conditions introduced under “Where” is searched for, and the instance that has been found is returned as $Var1 by the Select statement. Rooms connected to this instance are obtained by “$Var1.ConnectedSpace” using the “ConnectedSpace” property, and the number of the obtained rooms is assigned to “Rooms”. An absolute value of the difference between the heights of the floors of the obtained rooms, i.e., Rooms[0] and Rooms[1] (“Rooms[0].floor.height” and “Rooms[1].floor.height”) is obtained by the “Abs( )” function and the Door instance whose absolute value is equal to or larger than 20 cm is selected as “$Var1”.

### EXAMPLE 2

Another example to be discussed is where a corner at which a mirror is not installed should be found from among corners in a building. An example search expression of this case is illustrated below as a “search expression 2”.

### <Search Expression 2>

Select $Var1
Where $Var1,type==IfcCorner
$Var.Mirror==null

“IfcCorner” specifies an instance whose type is “Corner”. A Corner instance whose value for the Mirror property is null, i.e., a Corner instance where no mirror is installed is discovered, and this instance is returned as $Var1.

Next, a search example of the 3D space search is illustrated. For example, an exemplary search expression is illustrated to search for an object included in a 30 degree cone with respect to a certain azimuth from a certain starting point (viewpoint). The following “search expression 3” is one example thereof.

### <Search Expression 3>

Cone=3DCone(poinsts,dir,30)
Objects=3DGetInclude(Cone)

“3DCone(poinsts,dir,30)” represents an object which represents a cone having the angle of 30 degrees when viewed in the direction of “dir” from the starting point “points”. This object is given to “Cone” by an assignment statement. An object (component) included in this Cone is obtained by 3DInclude(Cone) and given to “Objects” by an assignment statement.

In this illustrated example, an object included in a specified range in the three-dimensional space is to be obtained. Meanwhile, there is also provided a command (3DIntersect) which obtains an intersecting region of specified objects. Also, logical operation of the specified objects, for example, a logical operation command (Intersect) to determine whether or not the specified objects intersect with each other is also available. In addition, various commands regarding the three-dimensional space are available.

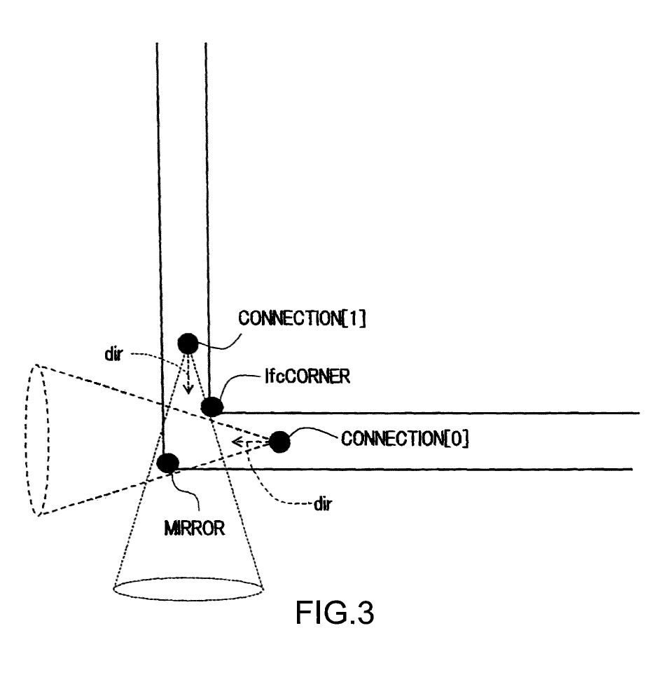

In the following, an example is illustrated where a search using information on the semantic relationship between the components (semantic relationship search) is combined with the 3D-space search. According to this embodiment, such a search expression is entered by the search expression entry unit 201. An example of this search expression is illustrated as a “search expression 4”. FIG. 3 illustrates a two-dimensional diagram of a certain section in a building schematically illustrating the content of the search expression 4. A passage of a linear line curves at a right angle at its certain intermediate point and a mirror is arranged at the corner.

### <Search Expression 4>

Select $Var1
Where $Var1.Type==IfcCorner
$Var1.Mirror!=null
Connections=$Var.AdjacentConnections
Cone=3DCorn(Connections[0].points,Connections[0],dir,30)
Cone2=3DCorn(Connections[1].points,Connections[1].dir,30)
Intersect=3DIntersect(Cone1,Cone2)
3DIsintersect(Cone1,Cone2)
3DInclude(Intersect, $Var.Mirror.geometory)
(3DIntercept(Connections[0].points,$Var.Mirror.geometory)∥
3DIntercept(Connections[1].points,$Var.Mirror.geometory))

This case example searches for such a corner that a mirror cannot be seen from a passage leading to a corner (IfcCorner) due to another object (obstacle) blocking a viewer's view even when a mirror is in fact installed at this corner (it should be noted that FIG. 3 does not explicitly illustrate the obstacle). The search expression entry unit 201 may be used to directly enter the above search expression, or a 3D editor may be used to define on a 3D screen a case where a mirror is installed at a corner but cannot be seen with the viewing angle from a passage leading to this corner, and it may be expanded into the search expression by the 3D editor or any other conversion application and thus the target expression may be entered.

“IfcCorner” specifies an instance whose type is “Corner”, According to this search expression, an instance that satisfies the conditions introduced under “Where” is searched for, and the instance that has been found is returned as $Var1 by a Select sentence. “$Var1,Mirror!=null” indicates that the value of the Mirror property is not null, i.e., a mirror is installed. The symbol “!” represents negation.

“$Var.AdjacentConnections” represents a connection point of a corner (Connections) and this is obtained as “Connections”. Here, two connection points, Leo, “Connections[0]” and “Connections[1]” are obtained.

“3DCorn(Connections[0] , points,Connections [0],dir,30) indicates a cone having an angle of 30 degrees when viewed from the location or the coordinate point (Connections[0],points) of the connection point “Connections[0]” in the direction specified for this connection point (Connections[0],dir), and inputs this cone in “Cone1”.

Likewise, “3DCorn(Connections[1].points,Connections[1].dir,30)” indicates a cone having an angle of 30 degrees when viewed from the location or the coordinate point (Connections[1].points) of the connection point “Connections[1]” in the direction specified for this connection point (Connections[1].dir), and inputs this cone in “Cone2”.

“3DIntersect(Cone1,Cone2)” represents a space where the cones Cone1 and Cone2 intersect with each other (intersecting portion), and inputs this space in “Intersect”, “3DIsIntersect(Cone2,Cone2)” is a logical expression to determine whether or not the cones Cone1 and Cone2 intersect with each other. If they intersect with each other, then it returns True. If not, it returns False.

“3DInclude(Intersect,$Var.Mirror.geometory)” is a logical expression to determine whether or not the intersecting portion “Intersect” includes the geometrical shape of the mirror ($Var.Mirror.geometory). If it includes the geometrical shape of the mirror, True is returned. If not, False is returned. The state where the geometrical shape is included envisages here a case where the entire geometrical shape is included. However, it may be defined such that it also includes a case where only part of it is included therein.

“3Dintercept(Connections[0],points,$Var.Mirror.geometory)” is a logical expression to determine whether an object (obstacle) blocking the viewer's view exists between the location of the connection point (Connections[0],points) and the geometrical shape of the mirror. If the obstacle exists, True is returned, and False is returned otherwise.

Likewise, “3DIntercept(Connections[1],points,$Var.Mirror.geometory)” is a logical expression to determine whether there exists an obstacle between the location of the connection point (Connections[1].points) and the geometrical shape of the mirror. If an obstacle exists there, then True is returned, and otherwise False is returned.

The symbol “∥” represents logical disjunction (OR).

Hence, “(3Dintercept(Connections[0],points,$Var.Mirror.geometor)∥3Dintercept(Connections[1].points,$Var.Mirror.geometory))” returns True if there exists an obstacle at least either between the location of the connection point (Connections[0].points) and the geometrical shape of the mirror and the location of the connection point (Connections[1].points) and the geometrical shape of the mirror. Otherwise, it returns False.

The above-described search expression searches for an instance that guarantees that all of the above conditions are True.

Although the search expression 4 is described declaratively in an SQL-like manner, procedural processing is performed in the part of the 3D-space search. In view of this, as will be described later, the part of the 3D-space search is separated from the remaining part (the part of semantic relevance search), and a search expression that supports these two parts (i.e., a search expression that can be interpreted by the semantic relevance searcher and the 3D space searcher) is generated.

The analyzer 101 analyzes the search expression and generates the structure information of the search expression. Specifically, the analyzer 101 expands the search expression into a syntax tree that complies with the grammar of the search expression as the structure information of the search expression. If there is any inconsistency or error in the search expression, the presence thereof may be notified to the user via a display device. Generation of the syntax tree may be done using existing methodology as appropriate, a specific example of which will be described later.

The search expression separator 102 analyzes the syntax tree and separates the syntax tree into a part (subtree) associated with the semantic relevance search and a part (subtree) associated with the 3D-space search, and generates therefrom the semantic relevance search expression and the 3D-space search expression (3D-space search function), respectively. Also, the search expression separator 102 generates information indicative of the integration procedure to integrate the semantic relevance search expression and the 3D-space search expression (integration script),

An example is described below where the syntax tree is generated from the above-described search expression 4, the generated syntax tree is separated into the part (subtree) associated with the semantic relevance search and the part (subtree) associated with the 3D-space search, and the semantic relevance search expression and the 3D space search expression (3D space search function) are generated therefrom, respectively.

<Semantic Relevance Search expression 1>
Select $Var1, $Connections
Where $Var1.Type==IfcCorner
$Var1.Mirror!=null
$Connections=$Var1.AdjacentConnections

$Var1 and $Connections are delivered as argument “corner” and “connections” to the following 3D space search function, respectively. How to read the semantic relevance search expression is obvious from the foregoing explanations and accordingly descriptions thereof are not provided here. It should be noted that the corner obtained by the semantic relevance search expression is not limited to one corner but a plurality of corners may be obtained if there are corners where no mirrors exist in the building. The semantic relevance search expression 1 is described in accordance with a predetermined query language.

### <3D-Space Search Function 1>

```
function 3Dfunc1(corner,connections){
var  Cone1  =
3DCorn(connections[0].points,connections[0],dir,30)
var  Cone2  =
3DCorn(connections[1].points,connections[1],dir,30)
Intersect = 3DIntersect(Cone1,Cone2)
if (3DIsIntersect(Cone1,Cone2)&&
  3DInclude(Intersect, corner.Mirror.geometory)&&
  (3DIntercept(connections[0].points,corner.Mirror.geometor) ||
3DIntercept(connectons[1].points,corner.Mirror.geometory)))
  return true;
else
  return false;
}
```

The 3D-space search function is expressed in accordance with a function& form of procedural language, and is constituted by variable definitions and a conditional statement. This function returns either True or False as a return value, “function 3Dfunc1” has the “corner” and the “connections” as its arguments, and receives them as a result of execution of the semantic relevance search expression (search result),

Two corns, i.e., “3DCorn(conns[0].points,connections[0].dir30)” and “3DCorn(conns[1].points,connections[1].dir,30)” are assigned to Cone1 and Cone2, respectively. Cone1 and Cone2 are each defined by “var.”

If “3DIsIntersect(Cone1,Cone2)” holds, if “3DInclude(Intersect, corner.Mirror.geometory) holds, and if “(3DIntercept(conns[0].points,corner.Mirror.geometory)∥3DIntercept(conns[1],points,corner.Mirror.geometory))) holds, then “True” is returned, “False” is returned otherwise.

Also, the search expression separator 102 generates the information indicative of the integration procedure to integrate the semantic relevance search expression and the 3D-space search expression (integration script). The following is an example of the integration script.

### <Integration Script 1>

```
(let res1 semantic relevance search result
  (booleanfilter
  (map (fun x (3Dfunc1 (get2nd x))) res1)
  (map (get1st res1))
  )
)
```

In the processing of the integration script, set operation (map processing) and filter processing (booleanfilter processing) are performed. The integration script adopts a format of description like that of a functional language in this embodiment, but it may be described in accordance with another format.

The symbol “( )” represents a list, and lists whose beginnings are any one of “union,” “map,” “let,” “get1st,” “get2nd,” and “booleanfilter” are treated as a special list having any one of the following meanings (it should be noted that, in the above example, “union” is not included).
“(let a b)” assigns “b” to the variable “a.”
“(union list 1 list 2)” calculates a sum set of the lists 1 and 2 as a list. For example, the result of union(a,b)(a,c) will be (a,b,c),
“map” applies “f( )” to the respective elements f( ) and obtains a set of the results. If (map fun1 (a b c d)), then (fun1(a), fun1(b), fun1(c), fun1(d)) will result.
It is assumed that “(get1st (a b))” obtains “(a)” and “(get2nd (a b))” obtains “(b).”
“(booleanfilter (true false false true) (1 2 3 4))” carries out filtering of “(1 2 3 4)” in accordance with True/False. Specifically, among “(1 2 3 4),” only an element or elements whose corresponding value is True are extracted therefrom. In this case, “(1 4)” is obtained,
“fun x” of “(map (fun x (3Dfunc1 (get2nd x))) res1)” defines an unnamed function. As a simplified example, “(fun x x*2)” is supposed. This means the unnamed function “(x)=2”. In this case, “(map (fun x x*2) (1 2 3 4))” will become “(map unnamed function (1 2 3 4)),” which in turn becomes “(unnamed function (1) unnamed function (2) unnamed function (3) unnamed function (4)). Since it is equivalent to the unnamed function “(x)=x*2”, “(2 4 6 8)” is obtained, Likewise, “(map (fun x (3Dfunc1 (get2nd x))) res1)” may or should be considered.

The semantic relevance searcher 104 performs searches based on the semantic relevance search expression 1, and obtains a set of the search results (which corresponds to the “semantic relevance search result” of the integration script). The individual elements of the set of the search results become the arguments of “3Dfunction1” which are “($Var1,Connections)”. The set of the search results is delivered to the search result integrator 103.

Here, the processing of “map” and “booleanfilter” described in the integration script is described based on a simplified case example,

“map f(a,b,c,d)” is a process of applying “f( )” to the respective elements in “f( )” and obtaining a set of the results, and in this case, “{f(a),f(b),f(c),f(d)}” is obtained.

“booleanfilter {false,true,true,false}{a,b,c,d}” only extracts from “{a,b,c,d}” an element or elements whose corresponding value is True, and in this case, “(b,c)” will result.

Hence,
booleanfilter
map f(a,b,c,d)
{a,b,c,d}
is expressed as:
booleanfilter
{f(a),f(b),f(c),f(d)}
{a,b,c,c}. Further, if “f(a),f(b),f(c),f(d)” are false, true, true, and false, respectively, then
booleanfilter
{false,true,true,false}
{a,b,c,d} will result, and
finally “(b,c)” is obtained.

The search result integrator 103 carries out, for a set of search results which are outputs by the semantic relevance searcher 104, calculation for all the elements in this set (search results) using the 3D space searcher 105 as indicated by the “map” function. For example, the number of elements of the set of the search results which are the outputs by the semantic relevance searcher 104 is identified as “3,” in other words, if the semantic relevance search result is given as {element 1, element 2, element 3}, then “3Dfunc1(element 1),” “3DfLmc1(element 2),” and “3Dfunc1(element 3)” are calculated.

The 3D space searcher 105 carries out the 3D-space search for the arguments given on the basis of the search result of the semantic relevance searcher 104 (carries out the aforementioned 3D search function 1), and returns the result by True or False, In the above example, “3Dfunc1(element 1),” “3Dfunc1(element 2),” and “3Dfunc1(element 3)” are calculated and the result is returned by True or False.

The search result integrator 103 selects a search result of the semantic relevance searcher 104 corresponding to True by the “booleanfilter” on the basis of the set of the search results returned from the 3D space searcher 105 (from the set constituted by the elements of True or False). In the above example, if “3Dfunc1(element 1),” “3Dfunc1(element and “3Dfunc1(element 3)” are true, false, and true, respectively, then
an element of True is selected from
booleanfilter
{true,false,true}
{element 1, element 2, element 3}
and “{element 1, element 3}” will result.

In this manner, a search of the building information DB 106 is separated into a part associated with the 3D-space search and a part that is not associated with the 3D space search (a part associated with the semantic relevance search), these portions are integrated, and thereby a desired search result can be obtained.

Next, as another example, processing at the time of the following “search expression 5” having been entered by the search expression entry unit 201 is described,

### <Search Expression 5>

Select $Var1,Objects
Where $Var1,Type==IfcCorner
$Var1,Mirror!=null
Connections=$Var.AdjacentConnections
Cone1=3DCorn(Connections[0].points,Connections[0].dir,30)
Objects=3DGetInclude(Cone1)

“Objects” is added to the Select statement. In the last statement, an object included in the cone (Cones1 is obtained by “3DGetInclude(Cone1) and assigned to the variable “Objects”. The number of objects obtained is not limited to 0 or 1, and multiple objects may be obtained. In the search expression 5, with regard to the angle at which the mirror is installed, an object included in the cone having an angle of 30 degrees when viewed from the connection point of this corner in the direction (dir) is obtained, and the instance of this angle ($Var1) and the obtained object (Objects) are returned.

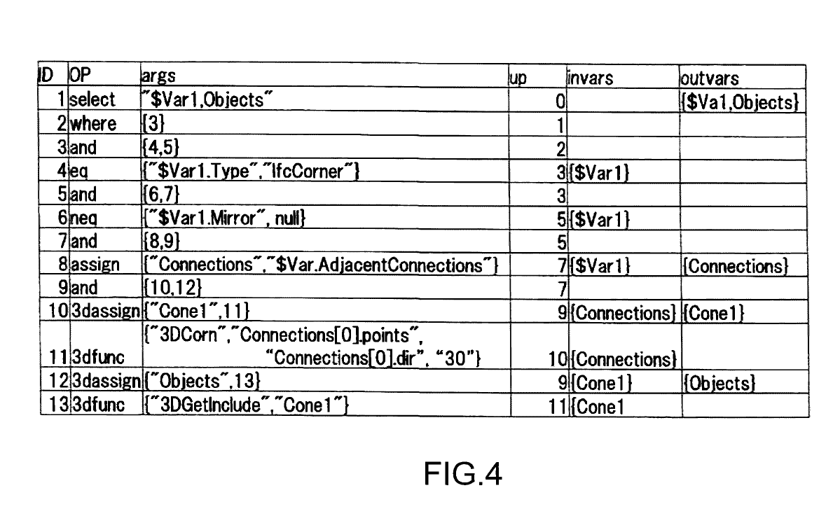

The analyzer 101 subjects the search expression 5 to the syntax analysis and generates a syntax tree, FIG. 4 illustrates the syntax tree obtained by the syntax analysis of the search expression 5. It should be noted that “eq”, “assign”, “and”, and the like are operators, i.e., pieces of information indicative of the meanings of the statements. “3dassign” and “3dfunc” indicate the fact that the statement at issue has been analyzed as being a statement associated with the 3D-space search as the result of the syntax analysis. As illustrated in FIG. 4, the syntax tree is constituted by thirteen statements.

Referring to FIG. 4, “ID” is the number given to a statement, “OP” is an operator, “ergs” are arguments, “up” is an ID of a higher-order statement that is higher than this statement, “invars” is a variable list to which this statement refers, and “outvars” is a variable list which this statement outputs. It is assumed here that statement IDs of lower-order statements are given to the logical operators (and, etc.) as arguments in the form of a list. Also, “11” of {“Cone1”,11} etc. of ID10 whose operator is “3dassigne” indicates the statement whose statement ID is 11. The syntax tree will be given as illustrated in FIG. 5 when it is expressed by a hierarchical structure tracing upward relationships.

The search expression separator 102 decomposes the analyzed syntax tree into the part (subtree) associated with the semantic relevance search and the part (subtree) associated with the 3D-space search, and expands them into the semantic relevance search expression and the 3D-space search function (3D space search expression), respectively. Also, the search expression separator 102 generates the integration script for integrating the search results of the semantic relevance search expression and the search result of the 3D space search expression, and delivers the integration script to the search result integrator 103. The specific aspects are illustrated below.

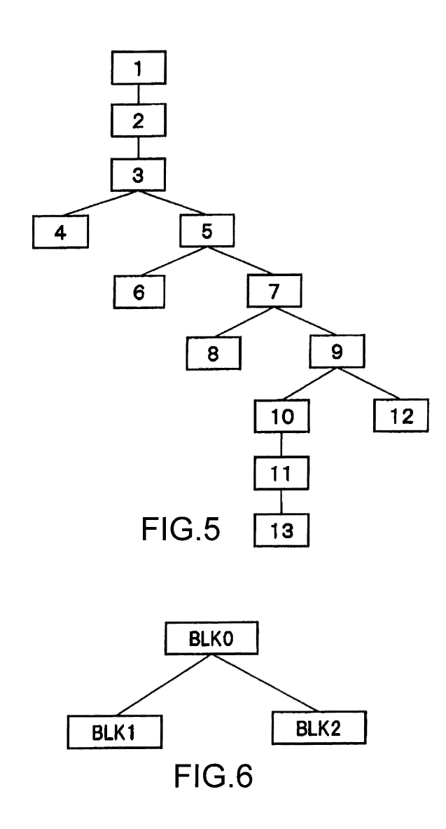

In the syntax tree, the part associated with the 3D-space search (“3dassign” and “3dfunc”) is identified and the syntax tree is separated in units of blocks (BLKs). Here, the entire syntax tree is represented as the entire block BLK0, the syntax tree (BLK0) can be separated into two blocks, i.e., a block BLK1 and a block BLK2. Specifically, the hierarchical structure of BLK0, BLK1, and BLK2 will be defined as illustrated in FIG. 6,

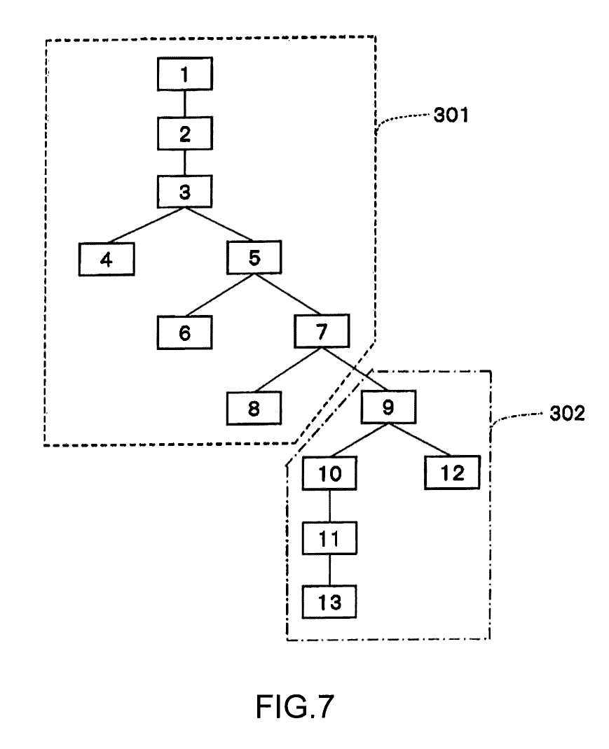

The subtree (block) “BLK1” in the syntax tree (BLK0) is constituted as illustrated by the frame 301 of FIG. 7 by eight statements, i.e., sentences 1 to 8. Meanwhile, the subtree (block) “BLK2” is constituted by five statements, i.e., sentences 9 to 13, as illustrated by the frame 302 of FIG. 7. In this manner, the syntax tree can be separated into two blocks.

### (Process of Extraction of Arguments)

The variables “invars” and “outvars” of the respective blocks are identified. At this point, if “outvars” corresponds to “invars” within one block, then they correspond to the input and the output within this block, so that they are excluded from the targets of the identification. Specifically, variables that are not inputs and outputs within one block are identified as “invars” and “outvars” of the block. Consequently, the following result is obtained.
“invars” of BLK0 is “none” (i.e., { }) and “outvars” is identified as {$Var1,Objects}.
“invars” of BLK1 is “none” (i.e., { }) and “outvars” is identified as {$Var1,Connections}.
“invars” of BLK2 is {Connections} and “outvars” is identified as {Objects}.

### (Creation of Semantic Reievance Search Expression)

The “outvar” in BLK1 identified by the extraction process to extract the arguments is added to the arguments of the Select statement. Specifically, the operation will proceed such that the argument ($Var1,Objects) of the Select statement of the original search statement is substituted by “$Var1,Connections.” The subtree after the substitution is restored to the format of the original SQL-like search expression, and thereby the following semantic relevance search expression is obtained. By virtue of this, the block (BLK1) is expanded into the semantic relevance search expression.
Select $Var1,Connections
Where $Var1.Type==IfcCorner
$Var1,Mirror!=null
Connections=$Var.AdjacentConnections

### (Creation of 3D-Space Search Function)

The “invars” of BLK2 is specified as an argument of the function. Based on the statement of “3dasign,” an assignment expression is generated. The argument of the “3dfunc” statement is expanded in accordance with a predetermined rule and the function is generated. In this example, this function resides on the input side of the assignment statement. The “outvars” of BLK2 is specified as the returned value (for example, “outvars” is returned by a return command). As a result, the following 3D-space search function (3D space search expression) is obtained. By virtue of this, the block (BLK2) is expanded into the 3D-space search function. It should be noted that the rule to give the format of the 3D-space search function to the tree structure is defined in advance.

function 3Dfunc1(Connections){
var Cone1 = 3DCorn(Connections[0].points,Connections[0].dir,
30)
var Objects = 3DGetInclude(Cone1)
return Objects;
}

### (Creation of Integration Script)

### [Clarification of the Dependency of Variables Between Blocks]

The dependency of variables between the blocks is identified. The variables “invars” and “outvars” of each block have already been described in the foregoing and are described as follows.
BLK0,{ },{$Var1,Objects}
BLK1,{ },{$Var1,Connections}
BLK2,{Connections},{Objects}

When the dependency of variables is extracted (the exchanges between variables are analyzed), a dependency from “$Var1” to “Connections” is obtained with regard to BLK1. With regard to BLK2, a dependency from “Connections” to “Object” is obtained. Hence, it can be appreciated that “Objects” correspond on a one-to-one basis to the initially given “$Var1.”

Since multiple “Var1” can be searched for, the format of the entire returned values will take the form of a list of pairs of “$Var1” and “Objects” as follows. It will be appreciated that there may be a case where the number of elements of the list is 1, {$Var1,Objects} corresponds to one element. {{$Var1,Objects},{$Var1,Objects}, . . . {$Var1,Objects}}

### [Selection of a Template]

Since the statement of the last output of BLK2 is a statement whose operator is “3dassign” or “3dfunc,” a template having the following type is selected.

```
(let res1 semantic relevance search result
  (map processing res1)
  )
)
```

As described in the foregoing, the symbol “( )” represents a list, and lists whose beginnings are any one of “union”, “map”, “let”, and the like are treated as the special list. With regard to “union” “map”, “let”, and the like, the explanations are briefly restated below.
“(let a b)” assigns “b” to the variable “a.”
“(union list 1 list 2)” calculates a sum set of the lists 1 and 2 as a list.
“(map fun1 (a b c d))” expands “fun1” into the respective elements and “(fun(a) fun(b) fun(c))” will result.
“(get1st (a b))” obtains “(a)” and “(get2nd (a b))” obtains “(b)”.

### [Analysis of Arguments]

As discussed in the foregoing, while the list of {$Var1,Connections} is returned as the semantic relevance search result, the 3D-space search function outputs “Objects” using “Connections” as an input. The entire search result is a list of “{$Var1,Objects}”. Accordingly, if the semantic relevance search result is expressed as “res1={{$Var1,Connections},{$Var1,Connections}, . . . ,{$Var1,Connections}},” then the first element (first sub-element) in the element and the second element (second sub-element) in the element are input to the 3D-space search function, and a list of pairs of the search results will be obtained for the respective elements in the list “res1”.

The description to obtain the list of results of the “processing” performed for the respective elements in the list “rest” is as follows.
(map “processing” source list=res1)

The “processing” corresponds to the pair of the first element (the first sub-element) in the element and the result searched for by inputting the second element (the second sub-element) in the element to the 3D space search function, i.e.,
(fun x ((get1st x) (3dfunc (get2nd x))).
The “fun x” indicates, as described in the foregoing, the unnamed function (x). The “x” indicates the element and, by way of example, “get1st x” obtains the first element (the first sub-element) of “x”.
Hence, finally the integration script will be obtained as follows.

(let res1 semantic relevance search result
(map (fun x ((get1st x) (3dfunc (get2nd x)) res1)
)

It should be noted, as can be appreciated from the above explanation, that “let res1 semantic relevance search result” means that the semantic relevance search results “{{$Var1,Connections},{$Var1,Connections}, . . . , {Var1,Connections}}” are all assigned to the “res1.”

Next, as still another example, processing is illustrated where the following “search expression 6” is entered by the search expression entry unit 201. As the difference from the search expression 5, the last statement additionally includes “In(Var1,Mirror, Objects),” “In($Var1,Mirror, Objects)” indicates whether “$Var1.Mirror” is included in the “Objects” set. If the state where “$Var1.Mirror” is included in the “Objects” set is described by a set operation, it will be described as “$Var1,Mirror∈Objects”.

### <Search Expression 6>

Select $Var1
Where $Var1.Type==IfcCorner
Var1.Mirror !=null
Connections=$Var.AdjacentConnections
Cone1=3DCorn(Connections[0].points,Connections[0].dir,30)
Objects=3DGetInclude(Cone1)
In(Var1.Mirror, Objects)

The processing up to generation of the integration script for the search expression 6 is illustrated below. The syntax tree and its generation process are not described here.

### (Creation of Integration Script)

### [Selection of a Template]

Since the statement of the last output of the block BLK2 is not a statement whose operator is either “3dassign” or “3dfunc,” a template having the following type is selected. Specifically, the statement of the last output is a statement which corresponds to “In($Var1.Mirror, Objects)”, which corresponds to a statement of logical operation (operator (OP) is “in”).

```
(let res1 semantic relevance search result
  (booleanfilter
  (map processing res1) result list)
  )
)
```

### [Analysis of Arguments]

First, the list of “{$Var1,Connections}” is returned as the semantic relevance search result whilst the 3D space search function outputs “Objects” using the “Connections” as an input. The entire search result is a list of “{$Var1}.” Accordingly, if the semantic relevance search result is expressed as “res1{{$Var1,Connections},{$Var1,Connections}, . . . , {Var1,Connections}}” then the second element (the second sub-element) in the respective elements in the list “res1” are input to the 3D-space search function, and the list of True/False which is pairs of the search results is obtained. If “$Var1.Mirror” is included in the “Objects” set, then it is True. If not included, it is False. In addition, in accordance with True/False, only elements corresponding to True are selected, and further a list extracting the first element (the first sub-element) of the selected elements (i.e., {$Var1, Connections}) is finally obtained.

The description to obtain the list of results of the “processing” performed for the respective elements in the list “res1” is as follows.
(map “processing” source list=res1)

Since the “result list” is a list of the first elements (the first sub-elements) of “{$Var1,Connections},” it is expressed as “(map get1st res1).”

Since the “processing” is the result of inputting the second element (the second sub-element) to the 3D-space search function, it is expressed as “(fun x (3dfunc (get2nd x)).”

Hence, the following integration script is finally obtained.

```
      (let res1 semantic relevance search result
(booleanfilter
  (map (fun x (3dfunc (get2nd x)) res1)
  (map get1st res1))
  )
)
```

In this manner, when the end of the 3D-space search expression is a logical expression (or a logical formula) as in the case of the search expression 6, “booleanfilter” is used that narrows down the answer depending on whether or not the expression (or the formula) holds.

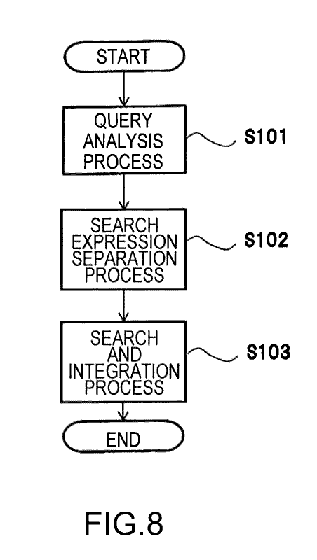

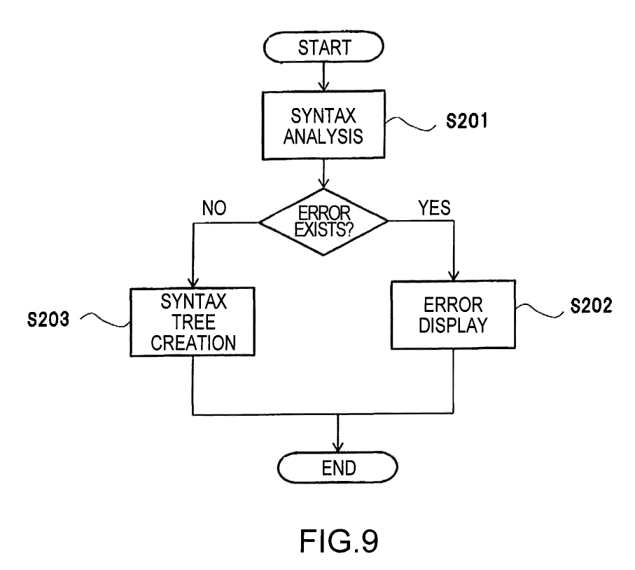

FIG. 8 illustrates a flowchart of the entire operation of the search device in accordance with this embodiment. The analyzer 101 performs the analysis process for the search expression entered by the search expression entry unit 201 and generates the syntax tree (S101). FIG. 9 illustrates a flowchart of the detailed operation of the analysis process. The syntax analysis is carried out for the search expression entered by the search expression entry unit (S201). If any error exists, the error is displayed (S202) and the process is terminated. If no error exists, the syntax tree is created (S203) and the process is completed.

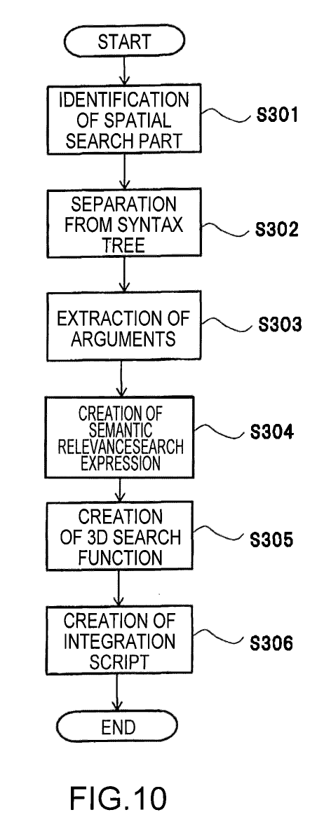

Referring again to FIG. 8, the search expression separator 102 performs the search expression separation process on the basis of the syntax tree. FIG. 10 illustrates a flowchart of the detailed operation of the search expression separation process. With regard to the syntax tree, the part associated with the 3D-space search is identified (S301) and the identified part (subtree) is separated from the syntax tree (S302). An argument or arguments are identified (extracted) from the separated part (S303). Also, the semantic relevance search expression is created from the part of the syntax tree other than the part that has been identified in the step S301 (S304). The 3D-space search function (3D-space search expression) is created from the part associated with the 3D-space search and the extracted argument(s) (S305). Finally, the integration script for integration of the search result of the semantic relevance search expression and the search result of the 3D space search function is created (S306). One mode of the integration script includes a script describing to apply the execution result (search result) of the semantic relevance search expression to the 3D space search expression and obtains the search result (a component) that satisfies the 3D space search expression from among the search result (components) of the semantic relevance search expression. It should be noted that the order of the steps of this flow is not limited to that illustrated in FIG. 10.

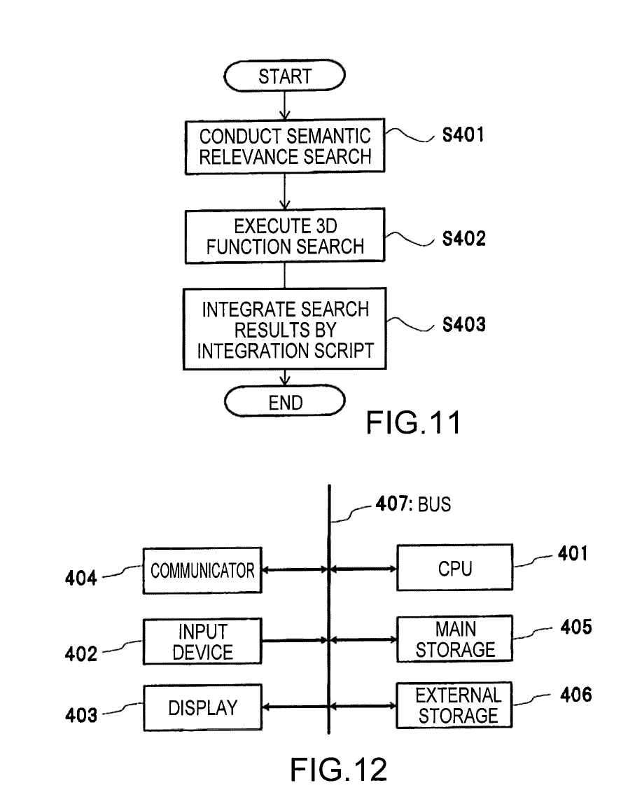

Still referring to FIG. 8, the search process is performed by the semantic relevance searcher 104 and the 3D space searcher 105 and subsequently the search result integrator 103 performs the integration process (S103). FIG. 11 illustrates a flowchart of the detailed operation of the search process and the integration process. The semantic relevance searcher 104 performs the semantic relevance search using the semantic relevance search expression (S401) and then carries out the 3D space search on the basis of the search result of the semantic relevance search and the search result of the 3D-space search expression (S402). Finally, these search results are integrated in accordance with the integration script (S403). More specifically, a component that satisfies the search expression entered by the search expression entry unit is identified by executing the 3D-space search expression on the basis of the search result of the semantic relevance search expression in accordance with the integration script. The search result integrator 103 outputs the obtained result (information on the component that has been found).

FIG. 12 illustrates an exemplary hardware configuration of the search device. The search device includes a CPU 401, an input device 402, a display 403, a communicator 404, a main storage 405, and an external storage 406, which are interconnected via a bus 407 so that communications can be performed with each other.

The input device 402 includes input devices such as a keyboard, a mouse, and the like. The display 403 includes a display device such as liquid crystal display (LCD), cathode ray tube (CRT), etc. The communicator 404 has a wired or wireless communication unit and performs communications in accordance with a predetermined communication scheme.

The external storage 406 includes, by way of example, a storage medium such as an HDD, an SSD, a memory device, CDR, CD-RW, DVD-RAM, and DVD-R. The external storage 406 stores programs that cause the CPU 401 to execute the functions of the individual processing units of FIG. 1. Also, the building information DB 106 is also included in the external storage 406. Here, although only one unit of the external storage 406 is illustrated, multiple units of the external storage 406 may be provided.

The main storage 405 under the control of the CPU 401 is used to load the control programs stored in the external storage 406 and store data necessary at the time of execution of the programs, data created as a result of execution of the programs, etc. The main storage 405 includes, by way of example, any suitable memory device such as non-volatile memory.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A search device comprising:
a hardware storage configured to store with regard to a plurality of components arranged in a three-dimensional space, semantic relationships between the components and three-dimensional information of the components;
an analyzer implemented by a processor configured to analyze an entered search expression including a first search condition and a second search condition to search a component satisfying the first search condition and the second search condition, wherein the first search condition defines a condition of a component using the semantic relationships and the second search condition defines a condition of a component using the three-dimensional information, to generate structure information of the entered search expression;
a first searcher implemented by a processor configured to interpret and execute a search expression based on the semantic relationships;
a second searcher implemented by a processor configured to interpret and execute a search expression based on the three-dimensional information;
a generator implemented by a processor configured to generate a first search expression that is adapted to be interpreted by the first searcher from a part of the structure information that corresponds to the first search condition, generate a second search expression that is adapted to be interpreted by the second searcher from a part of the structure information that corresponds to the second search condition, and generate integration information for integration of search results of the first search expression and the second search expression; and
a search result integrator implemented by a processor configured to integrate the search result of the first search expression by the first searcher and the search result of the second search expression by the second searcher on the basis of the integration information and identify a component that satisfies the entered search expression from the plurality of components.

2. The search device according to claim 1, wherein the integration information is a script describing that applies the search result of the first search expression to the second search expression and extract a component that satisfies the second search expression from the search result of the first search expression, and the search result integrator is configured to execute the second search expression in accordance with the script on the basis of the search result of the first search expression and identify the component that satisfies the entered search expression.

3. The search device according to claim 2, wherein the generator is configured to select the script to be used from a plurality of templates on the basis of an operator included in a last statement of a part corresponding to the second search condition in the structure information.

4. The search device according to claim 1, wherein the entered search expression includes a plurality of statements, and the generator is configured to determine whether each of the statement belongs to the part corresponding to the first search condition or to the part corresponding to the second search condition on the basis of whether each of the statements include a predefined function for three-dimensional search.

5. The search device according to claim 1, wherein the second search condition requires that an entire or a part of a component be included in a specified range in the three-dimensional space.

6. The search device according to claim 1, wherein the first search expression is described by a predetermined query language and the second search expression is described by a procedural language.

7. The search device according to claim 1, wherein the structure information is a syntax tree.

8. The search device according to claim 1, wherein the search result integrator is configured to output information indicative of the identified component.

9. The search device according to claim 8, wherein the search result integrator is configured to output, as the information indicative of the identified component, either a text identifying the identified component or three-dimensional information of the identified component.

10. The search device according to claim 1, further comprising an input device used to enter the search expression, wherein the analyzer is configured to analyze the search expression entered by the input device.

11. The search device according to claim 1, further comprising a display configured to display information output by the search result integrator.

12. The search device according to claim 1, wherein the plurality of components are components that constitute a building.

13. The search device according to claim 2, wherein the second search condition defines to extract a component an entire or a part of which is included in a specified range in the three-dimensional space from among the components indicated by the search result of the first search expression.

14. A search method comprising:
analyzing an entered search expression including a first search condition and a second search condition to search a component satisfying the first search condition and the second search condition, based on semantic relationships between components arranged in a three-dimensional space and three-dimensional information of the components, wherein the first search condition defines a condition of a component using the semantic relationships and the second search condition defines a condition of a component using the three-dimensional information, to generate structure information of the entered search expression;
generating a first search expression that is adapted to be interpreted by a first searcher from a part of the structure information that corresponds to the first search condition wherein the first searcher is configured to interpret and execute a search expression based on the semantic relationships;
generating a second search expression that is adapted to be interpreted by a second searcher from a part of the structure information that corresponds to the second search condition wherein the second searcher is configured to interpret and execute a search expression based on the three-dimensional information;
generating integration information for integration of search results of the first search expression and the second search expression; and
integrating the search result of the first search expression by the first searcher and the search result of the second search expression by the second searcher on the basis of the integration information and identify a component that satisfies the entered search expression from the plurality of components.
